(19) United States
(12) Patent Application Publication
(10) Pub. No.: US 2007/0015518 A1
(43) Pub. Date: Jan. 18, 2007

(54) Mobile resource location-based customer contact systems

(75) Inventors: Gregory J. Winter, Chesterfield, MO (US); Daniel D. Huber, Ballwin, MO (US); Naeem Bari, Chesterfield, MO (US)

Correspondence Address: HARNESS, DICKEY, & PIERCE, P.L.C, 7700 BONHOMME, STE 400, ST. LOUIS, MO, 63105, US

(73) Assignee: Agilis Systems, inc.

(21) Appl. No.: 11/486,717

(22) Filed: Jul. 14, 2006

Related U.S. Application Data
(60) Provisional application No. 60/699,583, filed on Jul. 15, 2005.

(51) Int. Cl. H04Q 7/20

(52) U.S. Cl. 455/456.1

(57) ABSTRACT

Mobile resource management systems including a location module configured to identify at least one of a plurality of potential customers having a location within a proximity zone. A mobile agent device is associated with the mobile agent and is configured to transmit a location signal indicative of a location of the mobile agent device. A mobile agent location module is configured to receive the signal and to determine the location of the mobile agent device as a function of the received signal. A customer communication module is configured to transmit a notification to the at least one potential customer as a function of the location of the mobile agent device.

### CROSS-REFERENCE TO RELATED APPLICATIONS

This application is based upon and claims the benefit of U.S. Provisional Patent Application Ser. No. 60/699,583 filed on Jul. 15, 2005 and entitled “MOBILE RESOURCE LOCATION-BASED CUSTOMER CONTACT SYSTEM AND METHOD.”

This application is also related to co-pending U.S. patent application entitled MOBILE RESOURCE LOCATION-BASED CUSTOMER METHODS that also claims priority to U.S. Provisional Patent Application No. 60/699,583 and having U.S. patent application Ser. No. [Attorney docket No. 5733-000004/US/02] filed by the applicants and/or assignees of the present application on Jul. 14, 2006.

The disclosures of the above applications are incorporated herein by reference.

### FIELD

The present disclosure relates to mobile resource management systems and, in particular, relates to systems for a mobile agent contacting a customer based on a planned route and/or a location of the mobile agent.

### BACKGROUND

The statements in this section merely provide background information related to the present disclosure and may not constitute prior art.

The growth in mobile wireless communications services has presented business and government entities with the ability of improving the management of resources such as agents, to provide services and/or products to customers. The evolving mobile communications services landscape includes, but is not limited to, land-based cellular voice and data services, satellite-based services targeted to trucking transportation markets, two-way paging services, Personal Communications Services (PCS), cellular-based Short Messaging Service, and unlicensed wireless internet access services.

Often services based on a Geographic Positioning Satellite (GPS) or other location-based technologies are integrated within existing communication networks as value-added enhancements to core network services to identify the geographic location of a customer or of mobile resources. Examples of location-based services include cellular subscriber emergency location, and value-added motor vehicle “personal security” services, such as General Motor's On Star™ (a registered trademark of General Motors Company). Associated services can include the management and dispatch of emergency mobile road service assistance.

However, as identified by the inventors, these typical systems and services do not sufficiently utilize the technologies sufficient to provide the often desired and required value-added services.

### SUMMARY

The inventors hereof have designed systems for managing mobile resources and customer contacts that can, in some embodiments, improve customer service and improve utilization and productivity of mobile resources.

According to one aspect, a mobile agent customer contact system includes a location module configured to identify at least one of a plurality of potential customers having a location within a proximity zone. A mobile agent device is associated with the mobile agent and is configured to transmit a location signal indicative of a location of the mobile agent device. A mobile agent location module is configured to receive the signal and to determine the location of the mobile agent device as a function of the received signal. A customer communication module is configured to transmit a notification to at least one potential customer as a function of the location of the mobile agent device.

According to another aspect, a mobile agent customer contact system including a memory that is configured to store a plurality of potential customers including a location of each potential customer and a routing module configured to create a route to be traveled by a mobile agent on a mobile agent schedule. A geographic area definition module is configured to create a proximity zone associated with, at least in part, the route. A customer location module is configured to identify at least one of the potential customers having a location within the proximity zone. A customer communication module is configured to transmit a notification to the at least one potential customer as a function of the route, the schedule, and a notification event.

According to still another aspect, a mobile agent customer contact system includes a routing module configured to create a route to be traveled by a mobile agent on a mobile agent schedule and a geographic area definition module is configured to create a proximity zone. A customer location module having a memory configured to store a plurality of potential customers including a location of each potential customer wherein the customer location module is configured to identify at least one of the potential customers having a location within the proximity zone. A mobile agent device is associated with the mobile agent and is configured to transmit a location signal indicative of a location of the mobile agent device. A mobile agent location module is configured to receive the signal and to determine the location of the mobile agent device as a function of the received signal. A customer communication module is configured to transmit a notification to the at least one potential customer as a function of the route and the location of the mobile agent device.

Further aspects of the present disclosure will be in part apparent and in part pointed out below. It should be understood that various aspects of the disclosure may be implemented individually or in combination with one another. It should also be understood that the detailed description and drawings, while indicating certain exemplary embodiments, are intended for purposes of illustration only and should not be construed as limiting the scope of the disclosure.

### BRIEF DESCRIPTION OF THE DRAWINGS

The present disclosure will become more fully understood from the detailed description and the accompanying drawings. The drawings represent only some of the exemplary embodiments, as other embodiments are also within the scope of the various embodiments.

FIG. 1 is a block diagram of a mobile resource management system according to one exemplary embodiment.

FIG. 2 is a block diagram of a mobile resource management system utilizing a wireless communication system according to another exemplary embodiment.

FIG. 3 is a block diagram of a mobile resource management system with defined geographic zones according to another exemplary embodiment.

FIG. 4 is a block diagram of a mobile resource management system for tracking a mobile user within authorized geographic zones according to another exemplary embodiment.

FIG. 5 is a block diagram of a computer system according to another exemplary embodiment.

FIG. 6 is a flow chart of a mobile resource management system providing pending delivery notification to a customer according to another exemplary embodiment.

FIG. 7 is a flow chart of a mobile resource management system for notifying a customer of a zone violation of a user according to another exemplary embodiment.

FIG. 8 is a flow chart of a mobile resource management system providing a customer delivery notification according to another exemplary embodiment.

FIG. 9 is a block diagram of a system for contacting customers as a function of a planned or current location of a mobile agent according to yet another exemplary embodiment.

FIG. 10 is a block diagram of an environment for contacting customers as a function of a customer contact zone and a planned or current location of a mobile agent according to still another exemplary embodiment.

FIG. 11 is a flow chart of a method of providing a service or product to a customer according to another exemplary embodiment.

FIG. 12 is a flow chart of a method of providing a service or product to a customer and updating the schedule of the mobile agent according to another exemplary embodiment.

FIG. 13 is a flow chart of a method of managing a plurality of mobile agents to provide products or services to a plurality of customers according to yet another exemplary embodiment.

FIG. 14 is a flow chart implementing a method of notifying a potential customer of a mobile agent being proximate to the location of the potential customer according to still another exemplary embodiment.

FIG. 15 is a flow chart illustrating a method of notifying a potential customer of the planned proximate location of a mobile agent to the customer location according to another exemplary embodiment.

Corresponding reference characters indicate corresponding parts, modules, features, or processes throughout the several views of the drawings.

### DETAILED DESCRIPTION OF THE EXEMPLARY EMBODIMENTS

The following description is merely exemplary in nature and is not intended to limit the present disclosure or the disclosure's applications or uses.

One exemplary embodiment includes a system for delivering a plurality of services to a plurality of customers. The system includes a customer service module, a mobile device communication module, a system management module, and a customer communication module. The customer service module is configured to receive a request for a service from each of the plurality of customers and identify a customer location for each of the customer service requests. The mobile device communication module is configured to communicate with a mobile device of each of the plurality of agents, and to receive a location and status of each of the plurality of agents.

The system management module determines a task profile for a task associated with each of the service requests as a function of each of the customer service requests and selects one or more tasks for a particular agent from among a plurality of agents. The system management module selects the tasks as a function of the task profile, the agent status, the customer location, and the agent location. The system management module further provides for scheduling the selected tasks for the particular agent and initiating the mobile device communication module to communicate the task profiles for the scheduled tasks to the particular agent. The customer communication module is configured for transmitting a notification to each customer associated with the selected task profiles as a function of the agent status and the agent location.

In some embodiments, the customer communication module is configured to receive a customer acknowledgement from the customer in response to the transmitted notification and wherein the system management module reschedules the tasks selected for the particular agent in response to a failure in receiving a customer acknowledgement. The system management module can also be configured to reschedule the task in response to the customer communication module failing to receive a customer acknowledgement in response to the transmitted notification and to retransmit the task profiles of the rescheduled task to the particular agent. The customer communication module can also be configured to receive a customer acknowledgement from the customer in response to the transmitted notification and wherein the mobile communication device communicates a customer status message to the particular agent in response to receiving the customer acknowledgement.

The system management module can also be configured to reselect the one or more tasks for a particular agent in response to the customer service module receiving a new request from one of the plurality of customers, said system management module further configured to reselect the one or more tasks for a particular agent as a function of the received new request, reschedule the tasks for a particular agent in response to the reselecting and retransmitting the task profiles for the rescheduled tasks to the particular agent.

The system management module can also be configured to assign a new task associated with a new customer request received by the customer service module to an agent as a function of a transit distance, a response time, an agent arrival time, and a customer requested time.

In various embodiments, a mobile device location module can be configured to receive the location from the mobile device communication module and to determine a map coordinate for the location. Such mobile device location and/or tracking modules can map the location of one or more agents and such mapping can include an indication of the status of one or more agents. For example, the system management module can be configured to predict a late arrival of an agent at a customer location, and the mobile device location module can map the customer location with a color indicative of the predicted late arrival. The mobile device location module can also provide a display of a route traveled by one or more agents.

In other embodiments, the system management module is configured to identify one or more agents who have deactivated a mobile communication device. Additionally, the system management module can select a particular agent having a transit distance less than a transit distance of another agent.

In some embodiments, a location-enabled mobile device can include text messaging such that when the mobile device communication module transmits the task profile, the location-enabled mobile device is configured to receive the transmitted task profile. Additionally, such devices can accept input entered by an agent, such as a job or agent status, and the device can transmit the status to the mobile device communication module. In one such exemplary embodiment, the agent can enter his time or a project or task time and the system management module tracks such time, for example as a time-clock for time worked by the agent. Similarly, the agent or the system management module can track the expenses associated with the agent's performing an assigned task or track the miles traveled by the agent. In other embodiments, the system management module can be configured to track supplies or equipment utilized by an agent during a task, further comprising an inventory module configured to track inventories of supplies or equipment in response to the utilized supplies. This can also include receiving an inventory of supplies or equipment from a barcode scanner, a Radio Frequency Identification Device (RFID), or other inventory identification system, by way of example. The mobile device communication module can receive an update to the inventory from a barcode scanner associated with the mobile device of an agent or alternatively by receiving data from mobile device menu-driven selections chosen by the mobile agent.

In other embodiments, the system management module can monitor a task status of one or more tasks and interface with an organizational management module that generates a report of the status of each task or the performance of one or more agents.

In other embodiments, a routing module can determine one or more routes for an agent to travel from their location to the location of a customer. This can also include selecting one or more tasks for a particular agent as a function of optimizing the travel distance and travel time of two or more agents to perform tasks for two or more customers. In other embodiments, the system management module can schedule the tasks selected for the particular agent as a function of optimizing the travel distance and travel time for the particular agent.

Another exemplary embodiment includes a system for managing a plurality of mobile agents to provide products or services to a plurality of customers, including a system management module, a mobile device communication module, an agent/mobile device location module, and a customer communication module. The system management module determines a work order for each product or service to be delivered to each of the plurality of customers with each work order including a location of the customer receiving the product or service. The system management module also selects an agent to deliver the product or service to each customer responsive to each work order and determines a notification parameter for communicating a notification to the particular customer. The mobile device communication module provides each of the work orders to one or more agents. The agent location or mobile device location module provides for identifying a location of an agent having a mobile device associated with the agent. It should be understood herein that the mobile device and an agent having a mobile device are used interchangeably throughout this specification as the mobile device is associated with the agent. The agent location module determines a location of a particular agent from among one or more agents for delivery of a particular product or service to a particular customer at a particular customer location in response to a particular work order. The customer communication module transmits a notification message to the particular customer as a function of the notification parameter, the location of the particular customer, and the location of the particular agent or at least the mobile device associated with the agent.

In some embodiments, the notification parameter can include a time interval designated as the time prior to an arrival time of the particular agent to the location of the particular customer. The notification parameter can include a variety of user or system defined parameters or characteristics including, by way of example, a communication address or number of the customer. In another embodiment that includes a routing module, the routing module can determine a route to be traveled by the particular agent to the customer location, and the customer communication module can transmit the notification message as a function of the route. The routing module can determine the route as a function of a route condition parameter such as, by way of example, an optimization factor, a route distance, a time, a transit time, a cost, and a unit cost.

In other embodiments, the system management module can determine the work order by identifying a piece of equipment or a material or supply that is required by the agent to provide the product or service to the customer. The module may also generate a requisition to an inventory entity or supplier to provide the equipment or supplies to the agent prior to their traveling to the customer location.

In another exemplary embodiment, a mobile resource management system includes a customer service module, an agent location module, a system management module, and a customer communication module. The customer service module receives a request from a customer for a service or product at a customer location. The agent location module identifies a location of each of a plurality of agents. The agent location module can include one or more interfaces for receiving location-based location signals from location devices of each of the plurality of agents. The system management module determines a task and a task profile as a function of the customer request and determines a status of each of the plurality of agents. The system management module also selects an agent to deliver the service or product to the customer from among the plurality of agents as a function of the task profile, the agent status, an inventory associated with the agent, the customer location, and the agent location. The customer communication module transmits to the customer a notification of a pending arrival of the selected agent at the customer location as a function of the determined agent status and the location of the selected agent.

In one embodiment, the customer service module can be a web-page interface for interfacing with the customer and for receiving the customer request along with the various details required to provide the service or product to the customer.

Generally, the customer request can include a customer requested delivery or appointment time, and the system management module can select an agent as a function of the customer requested delivery time. The customer request can also include a notification lead time that the customer desires an advanced notification prior to the delivery or appointment at the customer location. The system management module can determine an estimated time of arrival of the selected agent at the customer location, and the customer communication module can transmit the notification to the customer as a function of the customer notification lead time and the estimated time of arrival.

In some embodiments, a routing module can determine a route between the locations of one or more agents and the customer location, and the system management module can select the agent as a function of the determined route, such as an optimization of the travel distance or travel time of one or more agents for traveling to one or more customer locations. The routing modules can determine the routes for multiple agents to travel from their agent location to a single customer location, and the system management module can select a particular agent from among the plurality of agents as a function of the determined routes of the two or more agents. In some embodiments, the routing module can determine the route as a function of a route condition parameter selected from the group consisting of an optimization factor, a route distance, a time, a transit time, a cost, and a unit cost, by way of example. Additionally, in other embodiments the routing module can be configured to track a route traveled by an agent and graphically map the tracked route traveled by the agent. The routing module may also be configured to compare the tracked route traveled by the agent against a predetermined route for the agent or an authorized zone or location for the agent. In some embodiments, the agent location module can specify the allowable or authorized geographic zone for the agent and generate a zone violation notification responsive to the location of the selected agent being different than the specified allowable geographic zone.

The system management module can receive the route or initiate the transmission of the route to the selected agent or his communication device, where it may be displayed as a map or as text.

The system can also include a mobile device communication module for communicating with a mobile device of each of the plurality of agents. The mobile device communication module can transmit the customer location, such as a map coordinate or otherwise, to the agent. The mobile device communication module can be configured to transmit the task profile to the selected agent or receive an agent status message from an agent's mobile device. The agent status message can include, by way of example, a status parameter such as an availability of the agent, a pending availability of the agent, a status of a previously assigned task, a task delivery period, and a task completion time. Of course, other parameters and characteristics associated with the customer, the task, or the agent may also be included.

In some embodiments, the system management module can include an agent profile such that an agent is selected as a function of the agent profile or a parameter or component thereof. The agent profile can include an agent characteristic such as, by way of example, a skill, a certification, a grouping, a geographic allocation, and a rating associated with the agent. Additionally, the agent profile can include an equipment characteristic associated with the agent such as, by way of example, a vehicle type or capability, an equipment type or capability, a material type, an inventory of a material, supply or equipment, and an availability of a material, supply or equipment.

In other embodiments, the system management module is configured to determine an arrival time or a transit time of the selected agent at the customer location, and the communication module is configured to notify the customer as a function of the determined arrival time or transit time.

In some embodiments, the task profile can include one or more predefined customer contacts from input received from customers. The customer communication module can notify the customer as a function of the one or more customer contacts. The customer contacts can include, by way of example, a telephone number, an email address, a paging number, an instant messaging address, and an IP address.

The system management module can include an operator interface for receiving input from an operator. In some cases, an operator may utilize the operator interface to override the automatically selected agent, and select an agent based on the operator input.

The system management module can also determine an equipment supply or a material, or quantities thereof associated with or required for the delivery of the requested service or product to a customer or a task. This can also include determining the equipment, supply or materials for the task profile.

The customer service module can receive a customer request that includes a customer requested delivery period or appointment time and the system management module can select the agent as a function of the customer requested delivery period. Additional factors can also be utilized in this selection, such as the availability agent, the skills and/or inventor of the agent.

The customer communication module can receive an acknowledgement from the customer in response to transmitting the notification to the customer. In such a case, a mobile device communication module can transmit the task profile associated with the customer to the selected agent in response to the receipt of the customer acknowledgement. In the alternative, when a customer acknowledgement fails or is not received, the system management module can select another task for an agent in lieu of having that agent become idle waiting on customer availability. In other embodiments, the system management module can select another agent for a task following the customer communication module failing to receive the customer acknowledgement.

In some embodiments, an inventory management module provides for tracking equipment or supplies associated with one or more tasks. The inventory management module can include an interface for receiving inventory data from a barcode scanner, a Radio Frequency Identification Device (RFID), or other inventory identification system.

The inventory management module can also receive inventory data from a mobile device communication module receiving inventory data from a mobile device of an agent.

In another embodiment, an organizational management module can generate one or more reports that can be customized to meet particular operator needs from the variety of data within one or more modules of the system. A report can include operational data such as, by way of example, task completions, productivity, performances of an agent or group of agents, working periods for an agent, completion of a type of task, pending tasks, rescheduled tasks, task lengths, transmit times, arrival times, deactivations of a mobile device, deviations from a predetermined route by an agent, and violations of an allowable zone by an agent.

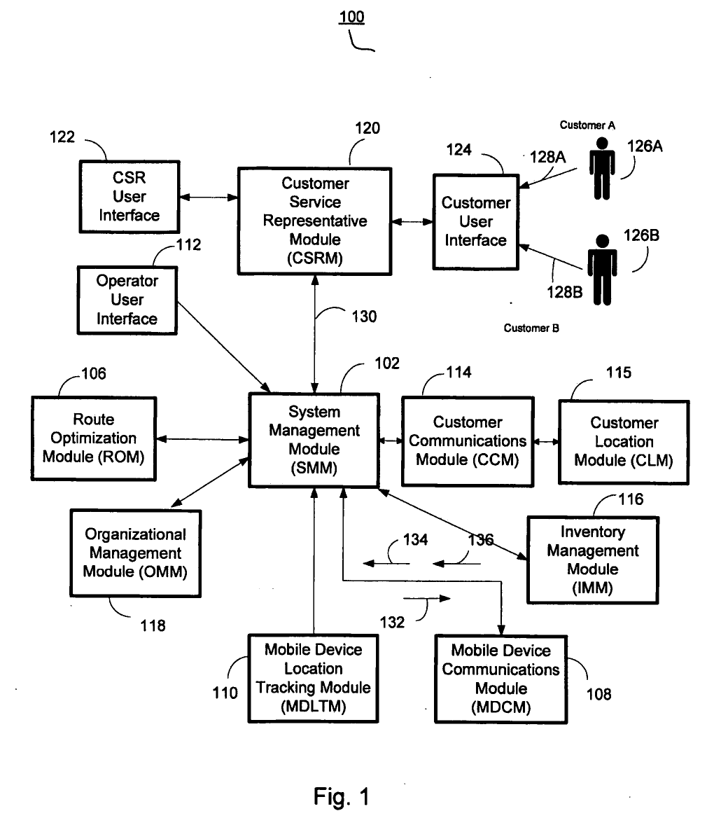

FIG. 1 illustrates a mobile resource management system (MRMS) 100 according to one embodiment. MRMS 100 provides a system and method for scheduling and managing mobile resources that deliver and support end-user services and/or products on a geographic service area basis.

FIG. 1 illustrates the functional modules of one exemplary embodiment of a MRMS 100 system. System modules are selectable by the end-user and can include any of the following module components: a System Management Module (SMM) 102, a Route Optimization Module (ROM) 106, a Mobile Device Communications Module (MDCM) 108, a Mobile Device Location Tracking Module (MDLTM) 110, a Customer Communications Module (CCM) 114, a Customer Location Module (CLM) 115, an Inventory Management Module (IMM) 116, a Organizational Management Module (OMM) 118, and a Customer Service Representative Module (CSRM) 120. Where existing functional modules already exist in an end-user's operations or system, such as the CSRM 120, the MRMS 100 can be configured to interface 130 with other system modules per end user-defined needs, such as existing or legacy systems. Interface 130 can be a custom communications interface or a standard communications interface, such an Ethernet, local area network (LAN), a dedicated private line communications link, or a private network link by way of example. The term end-user as used throughout this specification refers generally to any user (customer or otherwise) utilizing MRMS 100 for mobile resource management.

A given MRMS 100 exemplary embodiment can be configured as a single system or as multiple systems deployed within a geographic organizational structure and each can have its own unique customer service area and data base. In other embodiments, one or more modules or sub-modules of the system may share one or more components such as the data base, by way of example.

One processing module within the MRMS 100 is the System Management Module (SMM) 102 that interfaces to other system modules and provides overall management control for a given embodiment. An operator user interface UI 112 provides for interfacing with an operator/user such as for inputting schedules and in some cases overriding previously scheduled appointments and facilitates manual intervention/override of automated tasks. SMM 102 can receive input data from the CSRM 120, ROM 106, MDLTM 110, MDCM 108 and IMM 116 modules. The UI 112 can be standalone as indicated in FIG. 1 or can be contained within one or more other modules or systems, such as the SMM 102, by way of example. The SMM 102 can also receive information requests from the CSRM 120, MDCM 108, or IMM 116 and processes the information requests per user-defined requirements. While these functional modules are illustrated as individual modules, in some embodiments, these functions may be combined in specific end-user defined applications.

The SMM 102 automatically manages individual mobile resource schedules based upon system inputs that can include, but are not limited to, customer service orders, defined job task profiles with standard task intervals, individual mobile resource skill profiles, route optimization schedules for each mobile resource, mobile resource location tracking data and customer contact preferences with associated contact numbers. The SMM 102 can receive manual inputs via the Operator User Interface 112 to override automatically scheduled appointments by the system. Other actions under control of the SMM 102 include, but are not limited to:
1. control and management of the interactions between the SMM 102 and other functional system modules;
2. control of the storage and management of dynamic real-time data necessary to manage and optimize appointment schedules of mobile resources;
3. receipt of mobile resource location data from the MDLTM 110;
4. receipt of customer contact information from the CSRM 120;
5. receipt of customer service order data from the CSRM 120;
6. transmission of job completion data to the CSRM 120;
7. coordination with the MDCM 108 to transmit/receive work order information to/from the mobile resource via user-defined data templates; and
8. management of rescheduled appointments when confirmed appointments are not received from the CCM 114.

Functional interactions between the SMM 102 and associated system modules are described within each system module's functions. The MRMS 100 includes data interfaces between the Customer Service Representative Module (CSRM) 120 and the SMM 102. Input data to the CSRM 120 from a customer service representative is accomplished via the CSR User Interface 122. The CSR User Interface 122 can include a web page displayed on a video monitor (CRT) or a flat panel screen, a mouse, a pointing device, a voice activation/recognition input, a communication link, and/or a keyboard, by way of example. CSR operator inputs can include, but are not limited to, orders for a particular service, an installation appointment, and a repair appointment, where such appointments can be scheduled based upon particular service intervals for each requested product and/or service.

The Customer User Interface (UI) 124 to the CSRM 120 can include, but is not limited to, an automated internet web-based portal interface to enter service order/repair requests, local telephone carrier access, and local cellular wireless access. For example, Customer A 126A can access the order entry system using an Internet access 128A to the end-user's Internet site, while Customer B 126B can access the CSRM 120 via local landline and wireless carrier networks 128B.

In some embodiments, the end-user may host their own order-entry web site with its unique universal resource link (URL) Internet address that can include a home page and links to other hosted web pages. In other embodiments, the end-user may outsource the management of the web site to an Internet Service Provider (ISP). Customers can directly order services via the Internet through customer selected menus that have been defined by the end-user. The customer interface to the web-based portal pages is provided by customer-owned browser software. Browser software in common use includes, but is not limited to, browsers offered by Microsoft and Netscape, that reside on a customer's personal computer. Hosted web pages are end-user designed/defined and coded in various mark-up languages such as, but not limited to, hypertext mark-up language (HTML), extensible mark-up language (XML) and other device-specific mark-up languages. Customer product and service selections are typically chosen from a series of drop-down menu choices. Once the menu of order entries is completed, the customer typically “clicks” on a graphical submit button using a mouse and the order information is passed from the web portal server to the end-user's order entry system and the SMM 102.

Additional end-user specified information captured by a customer service representative or a web portal page during a customer contact can include, but is not limited to, the customer's preferred contact number for appointment follow-up/notification and appointment confirmation, alternative telephone contact number(s), customer's email address, customer's pager number, date of initial contact, time of initial contact, special installation requirements, unique access issues, and the presence of pets, by way of examples.

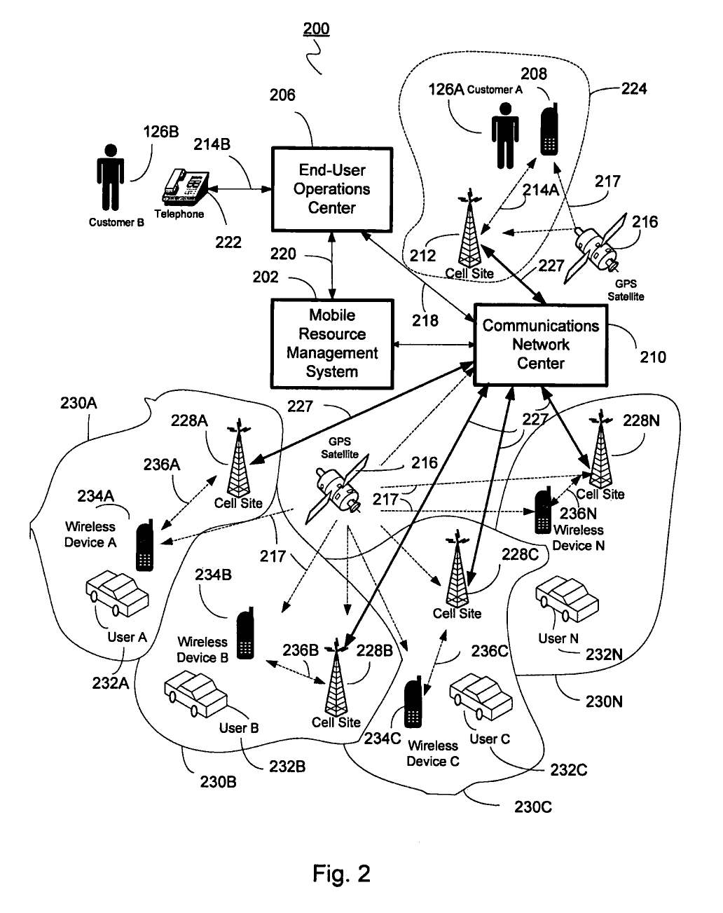

The Mobile Device Communications Module (MDCM) 108 manages communications to wireless devices via user-defined data screen templates utilizing the communications protocol required by a carrier's communications interfaces and the wireless device. While the exemplary embodiment illustrated in FIG. 2 communicates data templates to the display screen of a cellular phone, other embodiments can include templates for wireless personal digital assistants (PDAs), wireless personal computers or special purpose wireless communications devices as specified by the end-user. Such templates can require coding information in various mark-up languages unique to a given device, such as XML, and HTML, by way of examples. Communications interfaces can use any of the previously mentioned wireless access technologies and their associated communications protocols (such as 802.11a, 802.11b, 802.11g, and X.25, by way of examples), but is not limited to these technologies.

The wireless device used by the mobile resource receives and displays user-defined work order details for scheduled appointments and can also include additional task and job completion field entries that are completed by the mobile resource upon job completion and transmitted to the MDCM 108 via the carrier or private radio network to confirm the completion status for scheduled job tasks. Upon job completion, the MDCM 108 can communicate or update information for the next scheduled service appointment assigned to the mobile resource and transmit the updated template information via the appropriate network and network interface. Other information that can be communicated to/from the MDCM 108 via user-defined templates can include, but is not limited to, job status updates, time management data such as clock-in/clock-out, odometer readings between appointments, inventory used for a given appointment, or other user-defined information templates.

The SMM 102 interfaces to the Mobile Device Location Tracking Module (MDLTM) 110 to periodically or continuously receive an update location-based physical coordinate location data that monitors and tracks the travel of the mobile device used by the mobile resource throughout the user-defined work schedule. The MDLTM 110 can be executed using third-party software, such as GPStrac™ provided by LADS Network Solutions according to one embodiment. Location data per mobile resource device is maintained within the MRMS 100 for access by the system operator to display resource travel history by user-defined geographic areas or user-defined service area maps. Such location and map information can be used by the system operator to re-schedule appointments, as needed, based upon the closest available resource, and the system operator can override and re-schedule a previously assigned appointment. The system operator has the capability to display route activity for an individual mobile resource and for multiple mobile resources as defined by the needs of the end-user.

The SMM 102 interfaces with the Route Optimization Module (ROM) 106 under the control of the system operator. The ROM 106 is executed using third-party software that is generally available or can be customized to a particular embodiment. For a given day's planned activities within the end-user defined service area, the ROM 106 examines total work order demand, the job-skill profiles of available mobile resources, standard task intervals and geographic location of pending orders, and allocates work orders to individual mobile resources to minimize travel time and complete the maximum number of work orders. Once individual mobile resource schedules have been determined, the day's scheduled appointments and tasks can be transmitted to the mobile resource via user-defined data screens under the control of the MDCM 108. The optimized route and schedule data can also be accessed by the Inventory Management Module (IMM) 116 to determine the inventory needed by each mobile resource for the day's scheduled activities. Should end-user operational practices in a particular embodiment include daily reporting to a Work Center before departing to the first scheduled appointment, the required inventory can be ready for pick-up by the mobile resource at the start of each scheduled work period. In other embodiments, the end-user can seek to schedule appointments and manage inventory over multiple days or work shifts.

The SMM 102 interfaces to the Customer Communications Module (CCM) 114 to access customer contact requirements and contact information to confirm an appointment and job site access availability as originally scheduled. The CCM 114 schedules communications to the customer for the next appointment for a given mobile resource to confirm access availability for the next service appointment. Customer contact information collected by the Customer Service Representative or web-based portal with the initial customer service request can include home telephone number, work telephone number, email address or pager number or any other communications means preferred by the customer as the preferred contact means. The timing of the Customer contact by the MRMS 100 is user-defined. If the customer confirms the appointment, the system communicates the confirmation to the mobile resource and the mobile resource proceeds to the next appointment. If the appointment is not confirmed, the mobile resource serves the next scheduled appointment after appointment confirmation is received from the next scheduled customer. In other embodiments, the customer contact can only consist of customer notification that the service appointment is “on schedule” along with the time of the scheduled appointment.

The SMM 102 also includes interfaces to the Organizational Management Module (OMM) 118 to access standard operational reports that have been pre-defined by end-user management staff to access resource performance reports and to reallocate resources based upon geographic-specific service demands. Such reports can include user-defined report formats based upon operational needs and industry benchmarking metrics.

The reports from the OMM 118 can be accessed through the Operator User Interface 112 that can include, but is not limited to, remote personal computer (PC) access via a local area network (LAN), a PC local to the system operator or via requests for printed reports from the system operator staff. Typical reports can include, but are not limited to work orders by day; completed work orders by day, by geographic service area or by individual mobile resource and compiled at the regional organization level and/or by districts within the regional service area.

The SMM 102 interfaces to the Inventory Management Module 116 to maintain an inventory data base on a mobile resource-specific basis based upon scheduled appointments, services requested and spare parts inventory policies. Inventory can be allocated at the associated Work Center on a per mobile resource basis as specified by the end-user's inventory management practices. As completed work orders are communicated to the MRMS 100 using pre-defined data templates received from the mobile device via the MDCM 108, the SMM 102 updates the associated inventory data base. At the end of a given work day, individual mobile resource inventory is updated based upon completed job tasks and the next work interval's scheduled work orders and tasks.

Referring now to FIG. 2, one exemplary end-user embodiment of the MRMS 200 in an end-user's Operations Center communication facilities 206 includes an end-user that has elected to communicate with its mobile resources or agents via a local mobile carrier network that serves the end-user's geographic service area. The local wireless carrier network is represented in this exemplary embodiment by a Communication Network Center 210 and its associated cell sites 228 that provide wireless radio frequency (RF) signal coverage for specific geographic area segments within the carrier's service area. As illustrated in exemplary embodiment of FIG. 2, each service user (e.g., mobile agent) 232A-N physically resides in a unique cell site coverage area 230A-N served by cell sites 228A-N and maintains communications with the MRMS 202 through their wireless device 234A-N. Each wireless device 234A-N determines its physical location coordinates by monitoring GPS satellite system 216 location-based signals 217 and communicates this location information to the MRMS 202 via the cellular network.

Other embodiments can include multiple carrier networks or private carrier networks and can include other wireless technologies. Other wireless network technologies can include, by way of example, analog cellular systems with cellular digital packet data (CDPD) overlays, digital cellular Short Message Service (SMS), digital Global System for Mobile Services (GSM), digital cellular systems with code division multiple access (CDMA), spread spectrum access technologies, General Packet Radio Services (GPRS), digital Personal Communications Services (PCS) technologies, two-way narrowband PCS, two-way paging systems, unlicensed wireless data networks, and satellite communication systems offering Internet-based data communications services, by way of example. Some or all of these may include one or more forms of location technologies or services.

Location-based services (LBS) are being introduced by wireless carriers to provide their customers (and local government-based emergency service entities) information that is location-dependent. The subscriber location can be determined by the coverage area of the cell site presently serving the subscriber. Location accuracy is achieved when the mobile handset signal is received by multiple (3 or more) cell sites and the carrier determines the handset physical location using handset signaling data received from the multiple cell sites. Subscriber-specific location information can include the subscriber's telephone number and the carrier-determined handset physical location. Location-based technologies, include, by way of example, the global positioning system (GPS), assisted GPS (AGPS), advanced forward link trilateration (AFLT), angle of arrival (AOA), base transceiver station (BTS), enhanced forward link trilateration (EFLT), enhanced observed time difference (EOTD), and time difference of arrival (TDOA), by way of examples.

Referring again to FIG. 2, as one exemplary embodiment, a location-based service 217, illustrated by way of example as a GPS satellite system 216, is integrated within this exemplary embodiment to provide geographic location data to the mobile wireless field devices, such as cellular phones 208 and 234, or other devices such as a laptop PC or PDA configured with a wireless modem or location card. The location-based signals 217 are received and processed by wireless receiving devices to determine the location coordinates of the device/device user. The location-based signals 217 can also be processed within software-based mapping systems or location receiving terminals (including those that are commercially available from a variety of sources) to display a geographic position on a graphical map. Other wireless devices can be used in other embodiments that can include personal digital assistants (PDAs), two-way paging terminals, health-monitoring devices or child-tracking devices.

FIG. 2 also illustrates an interface 220 of the MRMS 202 with the end-user Operations Center communications facilities 206 that can include customer contact via cellular services 214A or wireline network services 214B. Customer A 126A prefers to be contacted by his cellular service 214A using cell site 212, while Customer B 126B prefers to be contacted by landline telephone 222 at his office number over a carrier wireline network 214B. End-user carrier communications services can also include private branch exchange (PBX) equipment, key system equipment, automatic call director (ACD) equipment, traditional central office exchange (Centrex) services or carrier paging services. End-user network embodiments can also include the use of web-based portals, private network facilities (fiber optic facilities, copper facilities, and radio network facilities, by way of examples). The exemplary embodiment of FIG. 2 illustrates how the MRMS 202 functions as the hub for the management of mobile resources within an end-user's customer service operations.

In this exemplary embodiment, the MRMS 202 manages communications and the flow of work order data on a geographically defined basis among operations staff, customers and the mobile resources that deliver and support the services offered by the end-user. Typical end-users can include, but are not limited to: telephone carriers; cable television service providers; satellite television service providers; electric utilities; gas utilities; water utilities; residential service companies such as plumbing contractors, electrical contractors, lawn maintenance services, pest control, and home health care; government services, such as fire, police, road maintenance, and emergency services; and business service companies, such as courier services, janitorial services, and office supply firms, by way of examples.

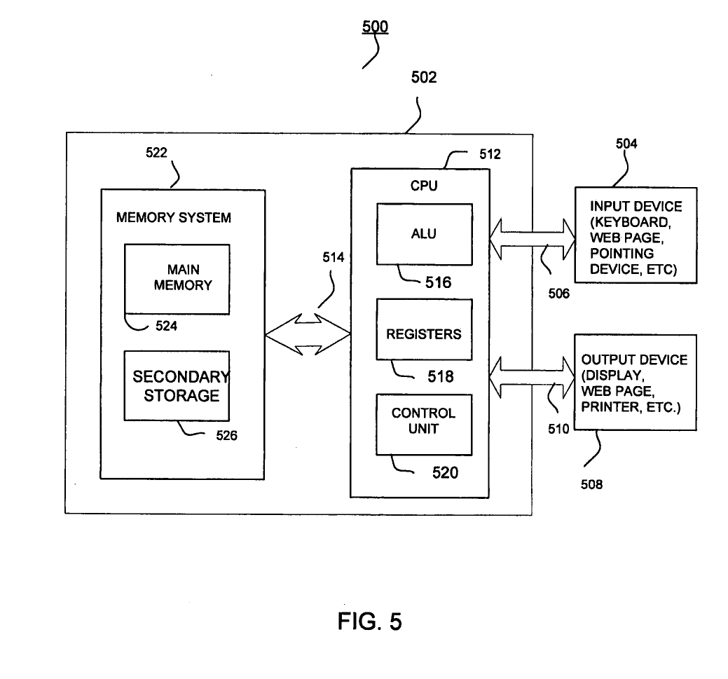

Referring now to FIG. 5, an operating environment 500 illustrates one exemplary embodiment of a computer system 502 for operating one or more components or modules as described above. A computer system 502 includes at least one high speed central processing unit (CPU) 512, a memory system 522, an input device 504, and an output device 508. These elements are interconnected by at least one bus structure 506, 510, and/or 514.

The illustrated CPU 512 is of a familiar design and includes an arithmetic logic unit (ALU) 516 for performing computations, a collection of registers 518 for temporary storage of data instructions, and a control unit 520 for controlling operation of the operating environment 500. Any of a variety of microprocessors, including at least those from Digital Equipment, Sun, MIPS, Motorola, NEC, Intel, Cyrix, AMD, Hewlett Packard, and Nexgen, is equally preferred for the CPU 512. The illustrated exemplary embodiment can operate on one or more operating systems and in one embodiment can operate on an operating system designed to be portable and/or applicable to any of these processing platforms.

The memory system 522 generally includes high-speed main memory 524 in the form of a medium such as random access memory (RAM) and read only memory (ROM) semiconductor devices, and secondary storage 526 in the form of long term storage mediums such as floppy disks, hard disk drives, magnetic tape media, CD-ROM, and flash memory, by way of examples, and other devices that store data using electrical, magnetic, optical or other recording media. The main memory 524 also can include video display memory for storing images and graphics that are transmitted to a display device. Those skilled in the art will recognize that the memory system 522 can include a variety of alternative components having a variety of storage capacities.

The input and output devices 504, 508 are also familiar. The input device 504 can include a keyboard, a mouse, and a physical transducer (such as a microphone), by way of examples, which may be used to input data to a user interface including a web page screen, and a program defined input template, by way of examples. Some communications devices, such as a network adapter or modem, can be used as input and/or output devices.

As is familiar to those skilled in the art, the computer system 502 further includes an operating system and at least one application program. The operating system is a set of software that controls the computer system's operations and the allocation of resources. The application program is a set of software that performs a task desired by the user, using computer resources made available through the operating system. Both are resident in the illustrated memory system 522. When multiple application programs are present within a given system embodiment, as with some embodiments, these individual application programs are often referred to as modules that are coded to perform specific functions and operational tasks.

In accordance with the practices of persons skilled in the art of computer programming, various embodiments is described herein with reference to symbolic representation of operations that are performed by the computer system 502. Such operations are sometimes referred to as being computer-executed. It will be appreciated that the operations that are symbolically represented include the manipulation by the CPU 512 of electrical signals representing data bits and the maintenance of data bits at memory locations in the memory system 522, as well as other processing of signals. The memory locations where data bits are maintained are physical locations that have particular electrical, magnetic, or optical properties corresponding to data bits. Various embodiments can be implemented in a program or programs, comprising a series of instructions stored on a computer-readable medium. The computer-readable medium can be any of the devices, or a combination of the devices described above, in connection with the memory system 522.

In operation, various embodiments address various operations, processes and methods of managing the provision of services and delivery of products and services to customers at one or more customer locations. Other embodiments address managing the agents delivering those products and services.

One business activity that has been challenging to manage is that of the “missed appointment” or “delayed appointment.” Service appointments are scheduled for the day and the resource assigned to provide the requested services can arrive at a given customer location and find that access to provide the service or product delivery is not available due to customer unavailability or last-minute schedule changes. In such cases, the service provider can have standard business practices to wait for a given time period before moving on to the next scheduled appointment and the service appointment delay often accumulates for subsequent appointments throughout the work schedule.

In other instances, the service provider resource can experience delays in completing work at an earlier scheduled appointment or traffic conditions prohibit the service resource from meeting the next scheduled service appointment or delivery, frequently resulting in customer dissatisfaction. Customer acceptance of the “morning” or “afternoon” appointment wears thin in competitive markets that demand “exceeding customer expectations”.

Various embodiments address the “missed appointment” or “delayed appointment” events by providing the capability for the system and/or system operator to confirm the next scheduled appointment for a mobile resource by contacting the next scheduled appointee/customer in advance of agent completion of the current scheduled appointment activity for that mobile resource. The advanced contact “time interval” is end-user specified and can be, but is not limited to, a function of the driving distance to the next appointment, the remaining time in the work schedule of the mobile resource, and the time required for the scheduled tasks at the next appointment, by way of examples. In other another embodiment, the contact interval is specified by the customer at the time of order entry.

In one embodiment, a method provides a service or a product to a customer and includes receiving a customer request for a delivery of the service or product and determining a task profile as a function of the customer request. A location and status of each of a plurality of agents is determined. The method also includes selecting an agent to deliver the service or product to the customer from among the plurality of agents as a function of the task profile, the agent status, and the agent location. The method further includes transmitting to the customer a notification of a pending arrival of the selected agent at the customer location as a function of the determined agent status and the location of the selected agent.

In yet another embodiment, a method provides services to a plurality of customers and includes receiving a request for a service from each customer and determining a task profile for a task associated with each service request as a function of each customer service request. A customer location for each customer service request is determined. A location and status of each of a plurality of agents is determined. The method also includes selecting one or more tasks for a particular agent from among a plurality of agents, the selection being a function of the task profile, the agent status, the customer location, and the agent location. The method further includes scheduling the selected tasks for the particular agent and transmitting the task profiles for the scheduled tasks to the particular agent. A notification to each customer associated with the selected task profiles is transmitted as a function of the agent status and the agent location.

The method can also include rescheduling the tasks selected for the particular agent in response to not receiving a customer acknowledgement of the transmitted notification or appointment confirmation.

In some embodiments, the method can include receiving a customer acknowledgement in response to the transmitted notification. In such embodiments, a customer status message can be provided to an agent in response to receiving the customer acknowledgement. If a customer acknowledgement is not received, the task can be re-scheduled and the task profiles re-transmitted to the same or a different agent.

In another embodiment, a new request from a customer is received and the tasks or agents are reselected as a function of the received new request and in consideration of the previous tasks. The tasks can be rescheduled for a particular agent in response to the reselection and the task profiles can be retransmitted to the particular agent.

The method can also include receiving a new request from a customer and assigning the task associated with the new request to a particular agent as a function of a parameter or characteristic such as, by way of example, the transit distance, response time, agent arrival time, agent profile, customer profile, or a customer requested time.

In other embodiments, the method can include mapping the location of one or more agents and can include predicting a later arrival of an agent at the customer location and mapping the customer locations with a color that indicates the predicted late arrivals. Similarly, the mapping can map the location of the agents and can include an indication of the status of the one or more agents, or a route traveled by one or more agents.

In other embodiments, the method can include determining routes for each of two or more agents to travel from their agent location to the locations of two or more customers and selecting one or more tasks for a particular agent as a function of optimizing a travel distance or a travel time for the two or more agents to perform the tasks for the two or more customers at the customer locations.

In still another embodiment, a method of managing a plurality of mobile agents to provide products or services to a plurality of customers includes determining a work order for each product or service to be delivered to each of the plurality of customers, each work order including a location of the customer receiving the product or service. An agent is selected from among a plurality of agents to deliver the product or service to each customer responsive to each work order. Each of the work orders is provided to one or more agents. The method further includes determining a location of a particular agent delivering a particular product or service to a particular customer at a particular customer location in response to a particular work order. A notification parameter for communicating a notification to the particular customer is determined and a notification message is communicated to the particular customer as a function of the notification parameter, the location of the particular customer, and the location of the particular agent.

In another embodiment, a method of notifying a customer of a location violation by an agent includes defining an authorized location for the agent, determining a location of the agent, and notifying the customer responsive to the agent location being different than the authorized location.

In some embodiments, the authorized location can include one or more boundaries separating the authorized location from a non-authorized location. In such cases, the customer can be notified in response to the agent location being equal to a boundary or a non-authorized location.

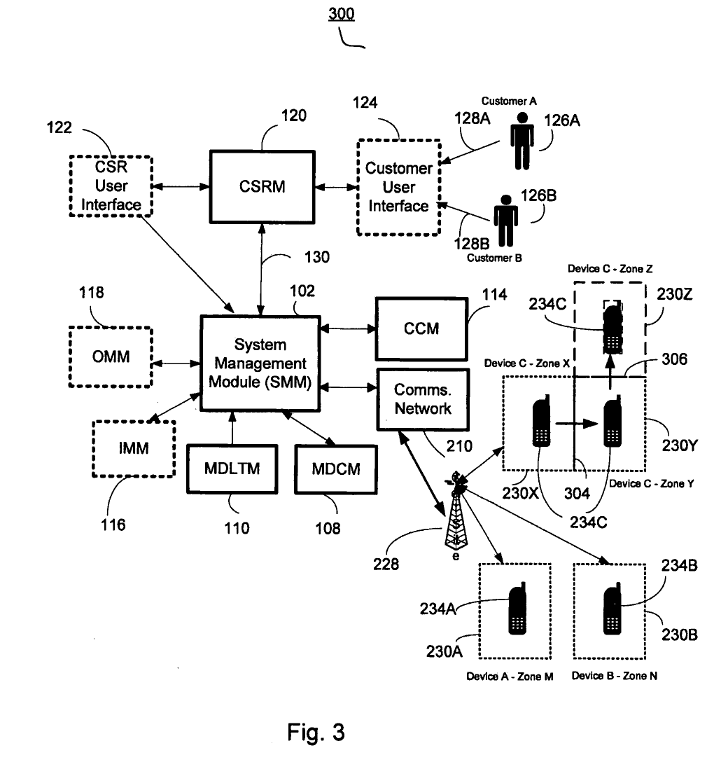

FIG. 3 illustrates one exemplary embodiment of a mobile resource management system 300 with three mobile resources, reachable via mobile Device 234A, Device 234B and Device 234C, respectively, that are currently working their scheduled activities. Worker C, presently in Zone X is scheduled to provide services to Customer 126A in Zone Y and then to Customer 126B in Zone Y. Zone X, illustrated as rectangle 230X, shares a common boundary 304 with Zone Y, illustrated as rectangle 230Y. Zone Y shares a common boundary 306 with Zone Z, also illustrated as rectangle 230Z. While these zones are illustrated as rectangular in shape in FIG. 3, they could have any boundary shape, including but not limited to boundaries defined by rivers, interstate highways, municipal boundaries, etc. Before mobile resource C completes the current job, the CCM 114 contacts customer 126B for the user-defined time interval prior to the scheduled appointment for mobile resource C to confirm the next scheduled appointment. If the appointment is confirmed, there is no schedule change for mobile resource C and mobile resource C proceeds to the next scheduled appointment. If the appointment is not confirmed, the CCM 114 contacts the next scheduled appointment for mobile resource C to confirm customer availability for an advanced appointment time. If confirmed, the rescheduled appointment is communicated to Worker C via MDCM 108, mobile resource C acknowledges receipt of the rescheduled appointment and proceeds to the next scheduled appointment. Customer 126A's service appointment must be rescheduled and the SMM 102 communicates this information to the CSRM 120.

A customer contact User Interface 124 initiated by the SMM 102 can be, but is not limited to, an Automatic Call Distributor (ACD) system that allocates automated calls among CSRs, an interactive voice response system (IVR), an interactive voice recognition system (IVRS), Internet email via an end-user web-based portal, customer pager notification, or Short Messaging Service notification communications, as specified by the end-user system configuration.

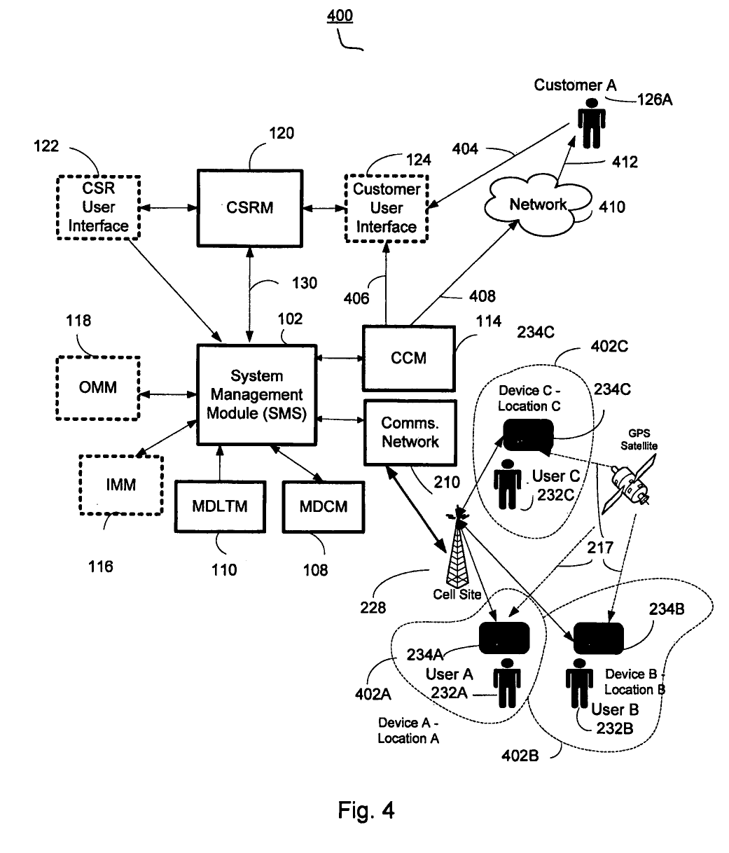

In another embodiment, a mobile resource management system provides for tracking a mobile user within a predetermined or authorized geographically defined zone. FIG. 4 illustrates an exemplary embodiment wherein the MRMS 400 monitors the user-defined geographical location of a plurality of users 232A, 232B and 232C. Each user has a location tracking device that periodically or continuously communicates its location to the MRMS 400 via a cellular network. The end-user 126A for this embodiment has defined a geographic boundary within which a specific user can be located for the plurality of users, as exemplified by boundaries 402A, 402B and 402C. Should any of the plurality of users move to a location at the boundary or outside each geographically defined area, the CCM 114 communicates the location violation to the Customer A 126A. Customer communications can be via network 410 having links 408 and 412 or can be via a customer user interface 124 having links 404 and 406, which can include internet links, by way of example. Network 410 can be a carrier network or a private network, by way of example. Such notification can include, but is not limited to, text messaging, an alerting signal with a text message, a paging message or pre-defined message formats. Exemplary applications of this embodiment can include, but are not limited to, user location monitoring with a prison/detention facility, physical location monitoring of health care patients (such as Alzheimer patients, and home-bound patients, by way of examples), and location monitoring of day care students.

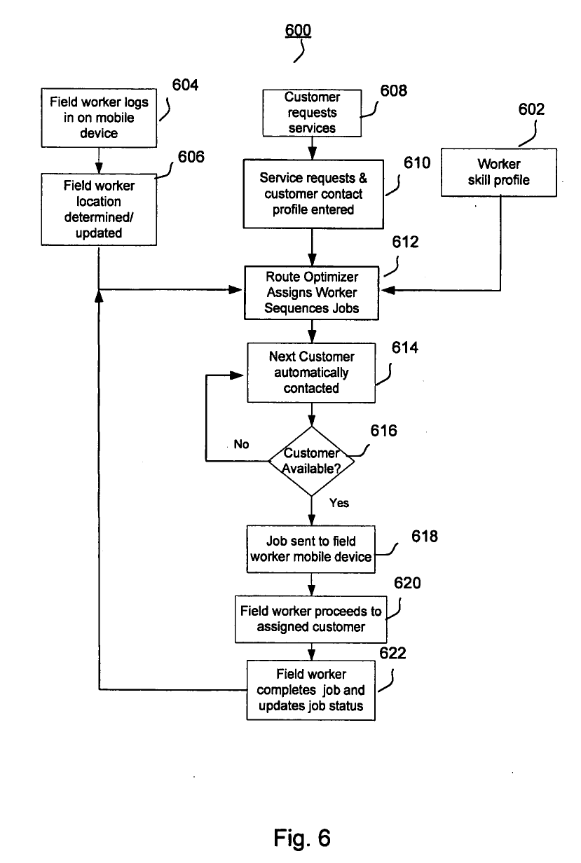

In another embodiment, the mobile resource management system provides a pending delivery notification to a customer. FIG. 6 illustrates one exemplary embodiment 600 wherein an agent/mobile resource receives real-time service delivery requests and scheduled appointments. In this embodiment, the agent logs on to their location-enabled mobile device in 604 at the beginning of their scheduled work period and the physical location coordinates for the device are determined and/or updated in 606 and transmitted to the Route Optimizer or ROM in 612 as one input element to allocated customer service requests. The Route Optimizer in 612 also receives worker skill profiles from 602 as additional decision inputs for allocation of customer service requests among a plurality of workers/agents. A plurality of customer service requests in 608 are also received by the Route Optimizer in 612 that includes contact profiles at 610 for each customer. The Route Optimizer at 612 assigns the requested tasks to the field worker considering the requested appointment time, worker physical location, customer location and customer contact interval. The CCM at 614 automatically contacts the customer to confirm availability in 614. If confirmation is received from the customer, the job is sent to the filed worker mobile device in 618, the field worker proceeds to the assigned customer 620, completes the requested tasks and updates the job status as complete in 622. Upon job completion status entry by the worker, the field worker's location is again determined and updated in 606 and the Route Optimizer in 612, again includes the worker within the pool of available resources for the next scheduled appointment. Should the customer not be available at 616, the Route Optimizer in 612 determines the next candidate customer appointment for the field worker considering the updated worker location, customer location, and customer contact time interval and the CCM 114 contacts the next customer to confirm availability at 614. This exemplary embodiment continues throughout the field worker's scheduled work period. Exemplary applications of this embodiment, include but are not limited to, product pick-up and delivery requests from business customers, express mail pick-ups and parts pick-up and delivery.

In another embodiment, the mobile resource management system provides for notifying a customer of a zone violation of a tracked user. One embodiment includes a system for notifying a customer of a location violation by the agent includes a customer service module, an agent location module, and a customer communication module. The customer service module defines an authorized location for the agent in response to the received request by the customer. The agent location module determines a location of the agent and the customer communication module transmits a notification to the customer in response to the agent location being different than the authorized location.

Such an embodiment can be configured to define the authorized location to include one more boundaries separating the authorized location from a non-authorized location, wherein the customer communication module transmits the notification responsive to the agent location being equal to a boundary or a non-authorized location. The agent location is tracked by a location system and/or location device as discussed generally above. The boundaries, locations or zones can be defined by the customer via a customer interface such as a graphical map on a web-page or may be defined by a system operator. Additionally, a profile for the tracked agent may be defined to include the authorized location or other items provided by the customer request. Additionally, a customer profile may be defined and include one or more parameters and characteristics associated with the customer request. This can include one or more customer contact and alarm notification methods, addresses, and priorities. The customer communication module can utilize the customer profile or the agent profile for transmitting the notification.

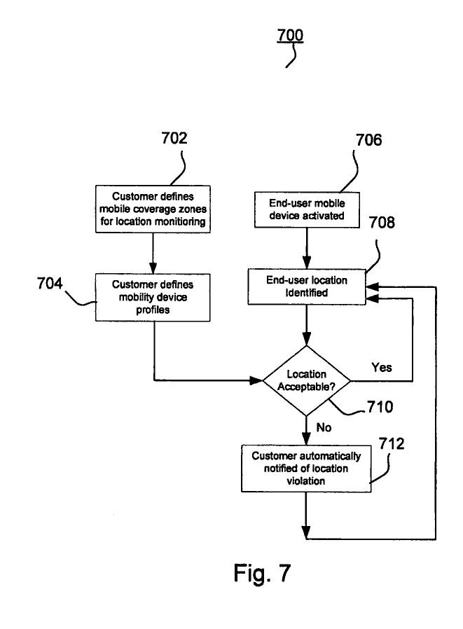

FIG. 7 illustrates one exemplary embodiment 700 wherein the customer application requires “geo fencing” of the end-user. In such applications, the customer defines mobile coverage zones in 702 that are permissible for a plurality of end-users with each end-user having a geo-fencing profile at 704 of permissible physical locations. The end-user device is activated in 706 by the customer for each user and the location-enabled device can be physically attached to the end-user. End-user location data is periodically or continuously transmitted by the location-enabled mobile device in 708 as defined by the customer. If the physical location of the end-user is within the customer defined boundary for that end-user in 710 the MRMS waits for the next location update from the end-user and again tests for location acceptability. If the current location is at or outside the customer defined boundary for that end-user, the CCM 114 automatically notifies the customer of a location violation at 712. Exemplary applications of this embodiment can include, but are not limited to, patient location monitoring, detainee monitoring, prisoner release program monitoring and day care client physical location monitoring.

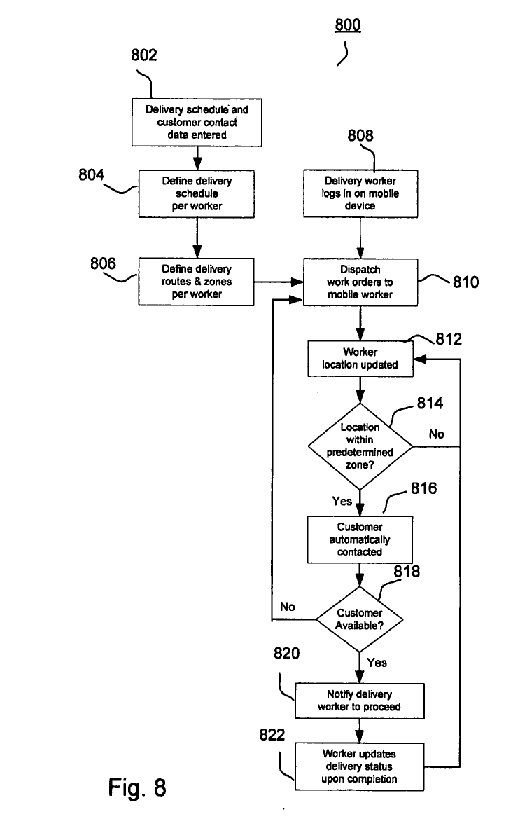

FIG. 8 illustrates another exemplary embodiment 800 of a MRMS 100. In this embodiment, the MRMS manages a plurality of deliveries and a plurality of delivery schedules for a plurality of delivery agents. Delivery schedules and customer contact information are entered into the system at 802, the system defines a plurality of deliveries for each worker's schedule at 804 and defines delivery routes and zones per worker in 806. At the beginning of a worker's scheduled work period/shift, the delivery worker logs in on his location-enabled mobile device at 808, a work order is dispatched to the mobile worker at 810 by the MDCM 108 using end-user defined data templates, the worker's physical location is updated as the worker travels to the first scheduled delivery location in 812. The MRMS 100 checks the worker's physical location against the predetermined geographic zone at 814 and if the worker is within the pre-defined zone, the customer is automatically contacted by the CCM 114 to confirm delivery availability. If the customer is available, the worker is notified in 820 to proceed to the scheduled delivery. Upon delivery completion, the worker updates the delivery status 822, and the worker's location is updated in 812. If the customer is not available or the current delivery has not been completed, the worker proceeds to the next scheduled delivery and the process repeats.

In another embodiment, a mobile agent customer contact system has a location module is configured to identify one of the potential customers having a location within the proximity zone. As noted above, the mobile agent device is associated with the mobile agent and can be configured to transmit a location signal indicative of the present location of the mobile agent location device and a mobile location agent module is configured to receive the signal and to determine the present geographic location of the mobile agent location device as a function of the received signal. A customer communication module can be configured to transmit a notification to the one potential customer as a function of or in response to the present location of the mobile agent device. The system can also include a memory configured to store a plurality of potential customers including the location of each potential customer and a memory configured to store a proximity zone associated with a mobile agent.

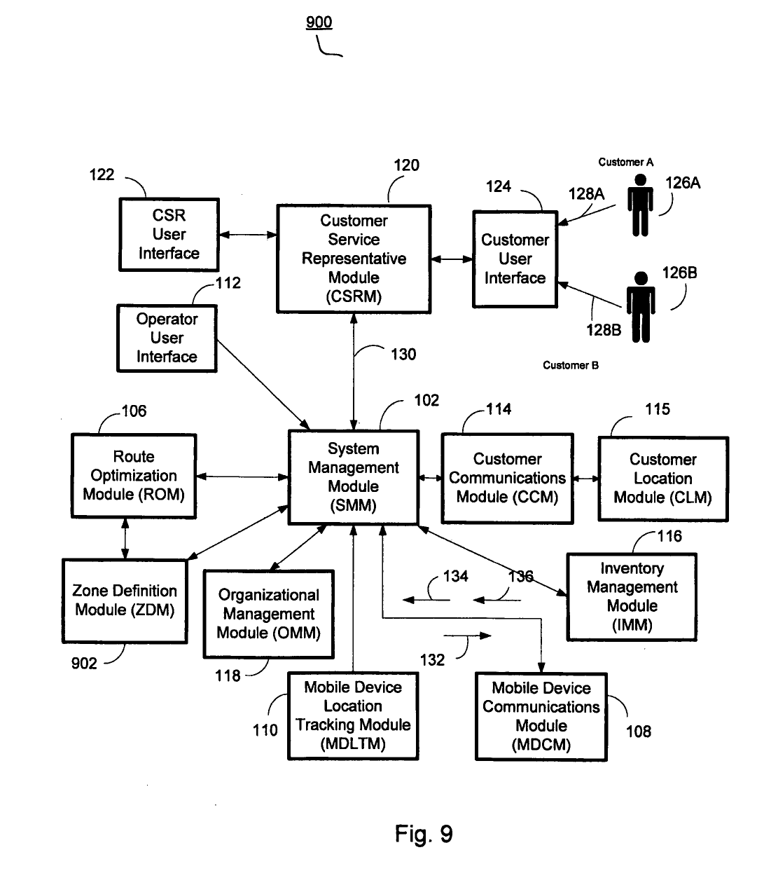

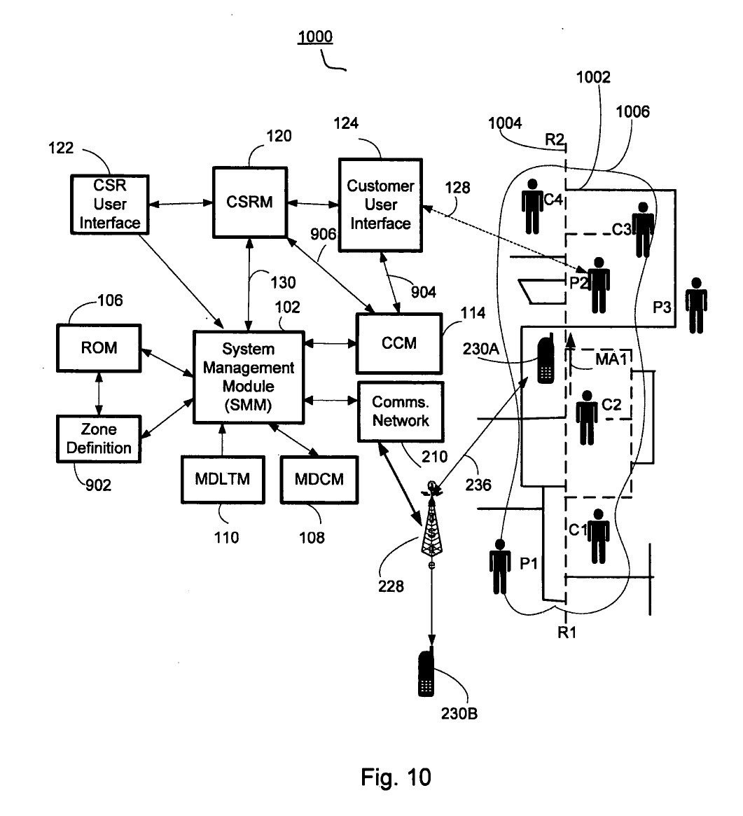

FIG. 9 illustrates one exemplary embodiment and FIG. 10 illustrates one exemplary operating environment. As shown in FIG. 9, a customer contact system 900 is similar in many respects to the system 100 of FIG. 1. However, as shown, a zone definition module 902 interfaces to the route optimizations module 106 and/or to the system management module 102. The zone definition module 902 provides for the definition of a proximity zone or area associated with one or a plurality of mobile agents. In some embodiments, the proximity zone can be defined by a map and provided to one or more users, operators, or mobile agents as a visual map. In other embodiments, the proximity zone can be identified by geographic coordinates or by landmarks, intersections, streets, towns, and subdivisions, by way of examples. For example, in one embodiment the proximity zone includes one or more boundaries associated with a mobile agent route.

A proximity zone can be defined based on a variety of user or system operator defined definition parameters and/or characteristics. For example, in one embodiment, the zone definition module 902 is configured to define the proximity zone having a proximity to a planned route to be traveled by a mobile agent. For example, a mobile agent may have an existing route or an existing set of customers or potential customers. The proximity zone can be defined around the route based on road configurations, groups of potential customers or based on other user definable factors. Those skilled in the art are generally aware of factors often used by sales or delivery personnel for identifying potential customer contacts.

One or more modules or components of system 900 can be configured to determine one particular potential customer from among a plurality of potential customers as a function of at least one of a profile of the mobile agent and a profile of the potential customer. This can include the route optimization module 106, the system management module 102, the customer service representative module 120, and/or the customer communication module 114, or a combination thereof. The identification or selection of one or more potential customers for each mobile agent managed by system 900 can be based on a variety of user or operator defined selection criteria. For example, potential customer selection or identification can be based on factors such as the current or planned location of the mobile agent, the availability or schedule of the mobile agent, the proximity of the potential customer location to that of the route or location or other customers or potential customers within the proximity zone, the frequency or history of customer contacts with the potential customer, one or more boundaries associated with a proximity zone, a predetermined profile for the mobile agent, a predetermined profile for the potential customer, a customer contact characteristic associated or assigned to the potential customer, an availability or schedule of a second mobile agent, a proximity of a second mobile agent to the customer location, traveled distance or time, and/or various travel or route optimization factors.

The customer communication module 114 interfaces with the system management module 102, the customer service representative module 120, and/or the customer user interface 124. The customer communication module 114 can provide for or initiate the contacting of potential customers, such as customer 126B, that are located in the proximity zone associated with one or more particular mobile agents. The customer communication module 114 can transmit the notification to the potential customer in response to a variety of user or system defined variables or characteristics. For example, in one embodiment the notification is transmitted as a function of the present location of the mobile agent device being close or proximate to the location of the potential customer. Such notification can be via any customer contact method, such as via a voice telephone call. In some embodiments, the method of contact can be operator defined or based on one or more preferred contact methods provided by or associated with the particular potential customer.

In some embodiments, the customer communication module 114 can be configured to prompt a potential customer to input a customer request. The customer communication module is also configured to receive a request (response of other input) from the potential customer to have an agent travel to the customer's location. In some such embodiments, the customer communication module 114 can also be configured to transmit a confirmation notification to the potential customer confirming that an updated route of the mobile agent includes the location of the potential customer or that the mobile agent is scheduled to visit them in response to their request.

The system 900 can also include the mobile device communication module 108 that is configured to transmit the route to the mobile agent device associated with each mobile agent.

The mobile agent device can be any device capable of generating a location identification signal and can be capable of receiving a set of route instructions and/or schedule for the mobile agent. For example, the mobile agent device can include a mobile telephone, a PDA, a laptop, or a custom location device. In some embodiments, the mobile agent device can generate a location signal based on or including a GPS-based location of the mobile agent.

As noted above, a routing or route optimization module 106 can automatically, or under the control of a user via the operator user interface 112, create a route to be traveled by each mobile agent. The routes can be selected based on an existing list or planned set of customers or potential customers such as a list of monthly customers to visit or ones that had made previous requests. Each such customer or potential customer to be visited has a physical location or address that is input into the system. The routing module 106 optimizes the route to be taken by the mobile agent generally as described above. However, the route can also be determined, at least in part, based on one or more potential customers that may be located in the proximity of the route.

The routing module 106 can also be configured to create the route as a function of the requests received from one or more customers or potential customers or the location of one or more potential customers. The routing module 106 can be configured to create a schedule for the mobile agent that includes one or more customers or potential customers within the proximity zone having placed a request. The routing module 106 can be configured to maximize the number of customer stops and/or maximize the potential revenue generation within the schedule for the mobile agent, by way of example. In other embodiments, the routing module 106 can be configured to maximize the selection of the route as a function of other factors or characteristics. Where the system 900 includes an agent contact module (not shown), such as the exemplary mobile device communications module 108, the routing module 106 can also be configured to update the route or routes for one or more mobile agents such that the mobile agents are provided the updated routes, even while in transit within the route. This real time updating of the route, or if included, the schedule of the mobile agent, can provide improved utilization of the mobile agent's time, increased productivity, and improved customer satisfaction.

Referring now to FIG. 10, an environment 1000 is illustrated that provides for contacting customers as a function of a customer contact zone and a planned or current location of a mobile agent according to some exemplary embodiments. As shown, the environment 1000 includes a system management module 102, with a route optimization module 106, a zone definition module 902, a customer service representative module 120, a customer user interface 124, a customer contact communication module 114, a mobile device communication module 108, a mobile device location tracking module 110 and a plurality of mobile agent devices 234A and 234B. Each of these modules can be implemented as one or more separate modules or can be combined into a fewer or greater number of discrete modules. Additionally, the modules, or functions that they perform, can be implemented, in whole or in part, by one or more other systems such as a legacy system.

A geographic area having a plurality of roadways or streets 1002 are illustrated by the solid road map on the right. A plurality of customers C1 to C4 and potential customers P1, P2, and P3 are illustrated as being located along the roadways 1002. Potential customers C1 to C4, or generally C, are used herein to denote a person or entity having a location along one of the roadways 1002 wherein the customer has placed an order for a service or product that requires an agent to travel to or visit the location of the customer. A potential customer P is a person or entity having a location along one of the roadways 1002 wherein the potential customer has not yet requested or ordered the product or service, at least at the present time, but may have in the past.

As described above, one or more components or modules evaluates the customers C and, in some embodiments, the potential customers P along the roadways 1002 and applies one or more routing algorithms or selection and definition parameters to define a route 1004 (from route point R1 to R2 and shown by a dotted line) or a zone 1006 (shown as being outlined by a curved line) along roadways 1002. For example, in one embodiment, the routing module 106 determines a route as a function of, at least in part, the location of the customers C along roadways 1002, so as to optimize the time and travel requirements of a mobile agent assigned to the route 1004. In such cases, the zone definition module 902 can define the proximity zone 1006 about or at least associated with the route 1004 based on a number of factors described above. This can include consideration of the location or business opportunity associated with potential customers P that can be included within the proximity zone. As shown in FIG. 10, the proximity zone 1006 has been defined to include potential customers P1 and P2 but to not include potential customer P3. The potential customer P3 is outside of proximity zone 1006 and therefore will not be considered for contact for an agent assigned to proximity zone 1006. In other cases, the proximity zone definition can include consideration of the allocation of a geographic area to other mobile agents, the expected travel path of one or more mobile agents, roadway conditions, or other factors and criteria that may be desirable by the operator or user of the environment 1000.

After the zone has been defined, one of the modules of environment 1000, for example, the system management module 102 or customer contact module 114, can initiate contacting one or more potential customers P located within the proximity zone 1006. This can be based on the expected or future travel of a mobile agent within the proximity zone 1006, or in some embodiments, based on a location of the mobile agent in proximity to or within the proximity zone 1006 or a potential customer P that has a location within the zone 1006. For example, as shown in FIG. 10, contact can be initiated with potential customer P1 as the mobile agent having mobile agent device 234A begins to travel the route 1004 at route point R1 when the mobile agent first enters the proximity zone 1006. The mobile agent continues to travel the route 1004 by visiting customers C1 and C2. As the mobile device location tracking module 110 tracks the location of the mobile agent device 234A by receiving location signal 236 at a receiving cell site 228. In this manner, the present location of the mobile agent can be determined. As discussed, the customer contact can be generated, at least in part, as a function of the determined location of the mobile agent. For example, at the location associated with mobile agent device 234A that is traveled past potential customer P1 within zone 1006 and along route 1004, potential customer P1 may not be contacted, but potential customer P2 which is yet to be reached can be contacted.

When a potential customer P within proximity zone 1006 has been identified, the customer contact module 114 or a similar module performing such function, can transmit or initiate a transmission or contact to the identified potential customer P. As noted this can be a direct contact or a contact using the customer user interface 124. By way of example, the customer contact module 114 can instruct or initiate the customer user interface 124 to transmit a telephone call to potential customer P2 (indicated as contact 128) in which a recorded message may be played. In other cases, an email or page or similar customer contact can be generated. In some cases, a prompt can be included in the customer contact requesting the potential customer P2 to enter a request for the mobile agent to stop at the potential customer's location. In such a case, the customer user interface 124 can receive the customer request (that may be an email, a voice or tone input, or a click on a webpage) and generate appropriate actions within the system such as updating the route and/or schedule of the mobile agent and/or notifying the mobile agent via the mobile agent device 234 of the request of the potential customer P2.

Of course, one skilled in the art will understand the environment 1000 can include or be adapted to address variations on the definition of the proximity zone, the events or criteria in which to identify potential customers, and methods or system for contacting the potential customer and still be within one or more aspects or embodiments illustrated by the exemplary embodiments herein.

For example, in another exemplary embodiment, a mobile agent customer contact system includes a memory configured to store a plurality of potential customers including the location of each potential customer and a routing module configured to create a route to be traveled by a mobile agent on a mobile agent schedule and configured to create a proximity zone associated, at least in part, with the route. A customer location module is configured to identify one of the potential customers having a location within the proximity zone and a customer communication module is configured to transmit a notification to the one potential customer as a function of the predetermined schedule and a notification event. In some embodiments, the memory is included as a sub-component of another system or module such as the customer location module.

In such embodiments, the notification event can include, but is not limited to, factors such as a notification time, a notification time interval, a proximity time, a proximity distance, and/or an arrival time.

According to still another embodiment, a method of providing a service or a product to a customer. The method includes receiving a customer request for a delivery of the service or product to the customer location and determining a route to be traveled by a mobile agent to include the location of the customer. The method also includes defining a proximity zone associated with the route, identifying a potential customer within the proximity zone, and determining the present location of the mobile agent. The method further includes transmitting to the potential customer a notification of the proximity of the mobile agent to the potential customer and receiving a request from a potential customer in response to the transmitting. The request is indicative of the potential customer desiring that the mobile agent travel to the location of the potential customer. The method also includes updating the route to include the location of the potential customer.

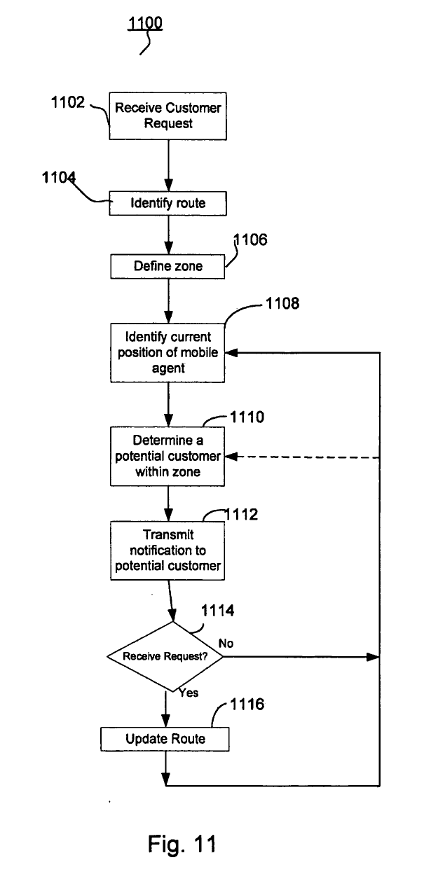

One exemplary embodiment of such a method is illustrated by the process flow chart of FIG. 11. As shown, a process 1100 begins with receiving a request in 1102 from a customer for an agent to visit the location of a customer. This could be to deliver a good, make a pickup, or for the mobile agent to provide a service to the customer. The customer contact system receives one or more of the customer requests in 1102 and identifies a route to be traveled by an agent in 1104. The route will include one or more of the customer requests. A proximity zone is defined in 1106 that is based, at least in part, on the route identified in 1104. For example, the zone can be defined about or around the route as illustrated in FIG. 10.

The location of the mobile agent is tracked to include a real time or close to real time identification of the current position of the mobile agent in 1108. Based on the location of the mobile agent in 1108, one or more potential customers that are located within the zone are identified or determined from among one or more potential customers in 1110. After one or more potential customers are identified in 1110, a notification is transmitted to the identified potential customers in 1112 to notify them of the proximity or availability of the mobile agent relative to their customer location. A prompt can be provided to the potential customer during the transmission or customer contact of 1112 and a request from the potential customer can be received in 1114. If a request is received in 1114, the route and/or schedule of the mobile agent can be updated in 1116. If a request is not received from one of the contacted potential customers, the process returns to identify the current position in 1108 or to determine another potential customer within the proximity zone in 1110.

In some embodiments of the method 1100, the route can also be transmitted to the mobile agent device associated with the mobile agent and can include transmitting the updated route. In other embodiments, a schedule for the mobile agent can be created that is associated with the route and can include the customer within the proximity zone having placed a request. The schedule and updated schedule can also be transmitted to the mobile agent.

Additional processes as discussed above relative to FIGS. 9 and 10 and throughout can also be included in various embodiments of process 1100.

According to yet another embodiment, a method of providing a service or a product to a customer that includes determining a route to be traveled by a mobile agent to include the location of one or more potential customers and defining a proximity zone associated with the route. The method also includes identifying one of the potential customers within the proximity zone. The method further includes transmitting a notification to the one potential customer indicating the pending proximity of the mobile agent to the potential customer, prompting the one potential customer to request the mobile agent to travel to the customer location, and receiving a request from the one potential customer for the mobile agent to travel to the customer location in response to the prompting; and updating the route to include the location of the one potential customer.

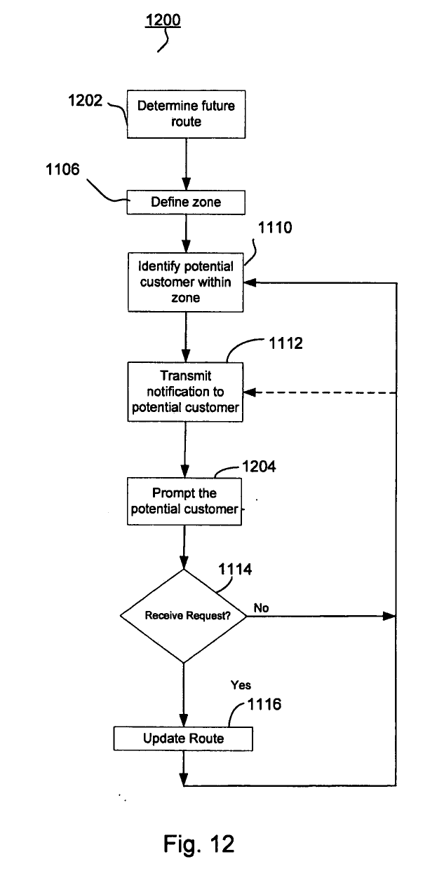

For example, FIG. 12 illustrates one exemplary embodiment of a method 1200 for providing a service or product to a customer. The method 1200 begins in 1202 with the determination of a future route to be traveled by one or more agents. A zone is defined about or as a function of the determined route in 1106. One or more potential customers located within the zone are identified in 1110. From this, a notification is transmitted to the potential customer or customers in 1112 and a prompt to the potential customer for requesting that the mobile agent visit or travel to the customer location is made in 1204. In response to the prompt, the potential customer can provide a request that is received in 1114 and the route and possibly a schedule are updated in 1116. If the potential customer does not positively respond to the prompt with a request in 1114, the process returns to identify another potential customer in 1110 or to transmit a notification to another identified potential customer. This later could occur due to the inability of the process to successfully contact one of the previously identified potential customers of 1110.

As generally discussed above, the method 1200 can include other processes as discussed relative to FIGS. 9 and 10. For example, the process 1200 could also include transmitting the route and the updated route to a mobile agent communications device associated with the mobile agent. Additionally, process 1200 could include determining a schedule for the mobile agent as a function of the route and updating the schedule as a function of the request from the one potential customer.

According to another embodiment, a method of managing a plurality of mobile agents to provide products or services to a plurality of customers. The method includes identifying the location of customers having requested a mobile agent and determining a route to be traveled by each mobile agent as a function of the requests received from the customers and the location of the customers. The method also includes defining a customer contact zone for each mobile agent as a function of the determined route and identifying potential customers located within each customer contact zone. The method further includes determining a present location of a particular one of the mobile agents and communicating a notification message to one of the identified potential customers located within the customer contact zone of the particular mobile agent. The method also includes prompting the one potential customer to input a request for the particular mobile agent to travel to the location of the one potential customer.

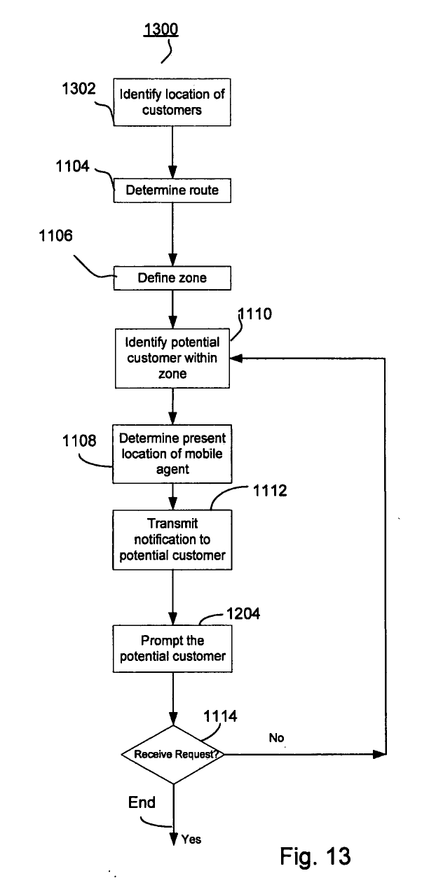

One such exemplary embodiment of such a method is illustrated in method 1300 illustrated by the process flow chart in FIG. 13. The method 1300 starts in 1302 with the identification of the location of one or more customers. Based on the location of the customers that need or have requested that an agent visit them, a route is determined in 1104 and a zone is defined in 1106, at least in part, as a function of the route 1104 and/or a mobile agent. One or more potential customers are identified in 1110 that have locations within the zone. The location of the mobile agent assigned to the zone is tracked and/or determined in 1108. Additionally, in some embodiments one or more of the potential agents can be selected as a function of the location of the mobile agent. A notification is transmitted to the potential customer in 1112 and a prompt is provided to the potential customer in 1204 to input or provide a request that the agent visit or travel to the potential customer's location. If a request is received from the potential customer in 1114, the process ends or continues to another function or process. If no request is received in 1114, the process returns to identify another potential customer within the zone as in 1110.

Of course, as is understood by those skilled in the art, one or more of the processes or process steps as described above related to FIGS. 9 through 12, may also be included within the process 1300 and still be within the scope of the exemplary embodiment of process 1300.

These can include, but are not limited to, updating the route of the particular mobile agent, transmitting to a mobile agent device associated with the particular mobile agent the route for the particular mobile agent and transmitting the updated route to the particular mobile agent device, and determining a schedule for each mobile agent associated with the route of the particular mobile agent. This can further include updating the route and the schedule for a particular mobile agent as a function of receiving a request from a potential customer to have the particular mobile agent travel to the location of the potential customer. In some embodiments, the process 1300 can be associated with a plurality of mobile agents, a plurality of routes and a plurality of proximity zones. As such, in other embodiments, the process 1300 can include reallocating one or more potential customers from one mobile agent route or proximity zone, to a second mobile agent route or proximity zone.

According to another embodiment, a method of notifying a potential customer of a mobile agent being proximate to the location of the potential customer that includes defining a route to be traveled by the mobile agent, defining a proximity zone for the mobile agent as a function of the route, and identifying the potential customer having a customer location within the proximity zone. The method also includes determining a present location of the mobile agent and notifying the potential customer as a function of the determined present location of the mobile agent.

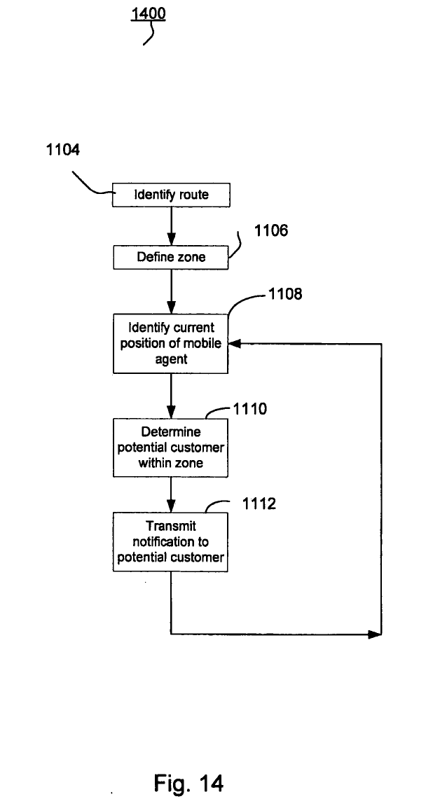

For example, as illustrated in FIG. 14 a method 1400 illustrates one exemplary embodiment of a process flow for notifying a potential customer that an agent is close to or will soon be close to the customer's location. The method 1400 starts at 1104 with the identification of a route to be traveled by an agent. After the route is identified, a zone is determined, mapped, or otherwise identified in 1106. The zone is based, at least in part, on the route of the agent. The current position of the mobile agent along the route is determined in 1108. One or more potential customers are then identified in 1110 that are along the route, within the zone, or associated with the future route and zone to be traveled by the agent. A notification to the potential customer is transmitted or initiated in 1112. After the transmission in 1112, the process repeats to identify or update as to the current position of the mobile agent in 1108 and/or to determine another potential customer within the zone in 1110.

As generally noted above, process 1400 can include one or more methods, processes, or steps as generally described above relative to FIGS. 9 through 13. These can include, but are not limited to updating the route of the particular mobile agent and transmitting to a mobile agent device associated with the particular mobile agent the route for the particular mobile agent and transmitting the updated route to the particular mobile agent device. Additionally, the process 1400 can also include determining a schedule for each mobile agent associated with the route of the particular mobile agent and updating the route and the schedule for a particular mobile agent as a function of receiving a request from a potential customer to have the particular mobile agent travel to the location of the potential customer.

In another embodiment, a method of notifying a potential customer of the planned proximate location of a mobile agent to the customer location that includes determining a route to be traveled by the mobile agent and defining a proximity zone for the mobile agent as a function of the route. The method also includes identifying the potential customer having a customer location within the proximity zone from among a plurality of potential customers. The method includes notifying the potential customer of the planned proximity of the mobile agent to the customer location.

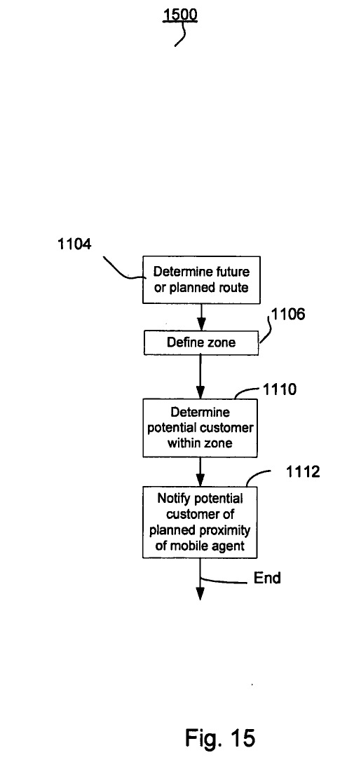

One such embodiment is illustrated in method 1500 of the process flow chart in FIG. 15. In this example, the future route of one or more mobile agents is determined in 1104. The routes can be defined by one or more methods as described above or otherwise known to those skilled in the art. In 1106, the proximity zone for the future route is defined as generally described above and throughout this specification. One or more potential customers located within the defined proximity zone are identified or determined in 1110 based in part on their location in the proximity zone, but possibly based on a variety of other selection factors, as discussed generally throughout the specification. In 1112, the identified potential customer or customers are notified of the planned or future proximity to their location of a mobile agent.

As discussed above, the proximity zone can be defined to include one or more boundaries associated with the route of a mobile agent. In such a case, the potential customer can be selected and notified, in response to the mobile agent location being within the boundaries or having crossed a boundary within or around the proximity zone.

The process 1500 can also include one or more of the processes discussed above relative to FIGS. 9 through 14. For example, this can include, but is not limited to receiving a customer request from a customer in response to notifying the potential customer and redefining the route to be traveled by the mobile agent to include the location of the customer from which the request was received. This can also include determining an agent profile for the mobile agent and/or determining a customer profile for the potential customer and performing one or more of the steps or processes of process 1500 as a function of one or both of the profiles such as determining the potential customer of 1110 or notifying in 1112 the potential customer is a function of the agent profile and the customer profile.

Additionally, the process 1500 can include transmitting a location signal from the present location of the mobile agent, wherein determining the present location of the mobile agent is a function of the location signal. A schedule can be determined for the mobile agent associated with the defined route and the schedule can be updated as a function of receiving a request from the potential customer to have the mobile agent travel to the location of the potential customer. The determination of the potential customer or the notifying the potential customer can be a function of a variety of factors such as, by way of example, maximizing the number of customer stops for an agent within the zone or maximizing the potential revenue generation within one or more schedules or routes of the mobile agents.

In other embodiments of process 1500, the present location of the mobile agent device and therefore the mobile agent can be determined.

It should be generally understood that one or more embodiments can be implemented as computer executable instructions operable on a computer or computing environment as generally described above and relative to FIGS. 1 to 5. Such instructions can be contained in a memory of the computer or computing environment or can be embodied as computer-readable medium. Additionally, it should be understood that the terms “as a function of” used herein can generally include “in response to” or “responsive to” or other system processing functionality.

Further areas of applicability will become apparent to those skilled in the art. It should be understood that the detailed description and specific examples, while indicating one or more preferred embodiments, are intended for purposes of illustration only and are not intended to limit the scope of the various embodiments. The description of the various embodiments is merely exemplary in nature and, thus, variations that do not depart from the gist of the disclosure are intended to be within the scope of the disclosure. Such variations are not to be regarded as a departure from the spirit and scope of the disclosure. As various changes could be made in the above exemplary constructions and embodiments and exemplary methods without departing from the scope of the disclosure, it is intended that all matter contained in the above description or shown in the accompanying drawings shall be interpreted as illustrative and not in a limiting sense.

When introducing aspects or embodiments, the articles “a”, “an”, “the”, and “said” are intended to mean that there are one or more of the elements. The terms “comprising”, “including”, and “having” are intended to be inclusive and mean that there can be additional elements other than the listed elements.

It is further to be understood that the steps or processes described herein are not to be construed as necessarily requiring their performance in the particular order discussed or illustrated. It is also to be understood that additional or alternative steps or processes can be employed.

What is claimed is:

1. A mobile agent customer contact system comprising:
a location module configured to identify at least one of a plurality of potential customers having a location within a proximity zone associated with a mobile agent;
a mobile agent device associated with the mobile agent and configured to transmit a location signal indicative of a location of the mobile agent device;
a mobile agent location module configured to receive the location signal and to determine the location of the mobile agent device as a function of the received location signal; and
a customer communication module configured to transmit a notification to the at least one potential customer as a function of the location of the mobile agent device.

2. The system of claim 1, further comprising a memory configured to store a plurality of potential customers including a location of each potential customer; and
a memory configured to store a proximity zone associated with a mobile agent.

3. The system of claim 1 wherein the customer communication module is configured to prompt the at least one potential customer to input a customer request and to receive a request from the at least one potential customer for the mobile agent to travel to the location of the at least potential customer.

4. The system of claim 1 wherein the customer communication module is configured to transmit the notification as a function of the location of the mobile agent device being proximate to the location of the at least one potential customer.

5. The system of claim 1, further comprising a routing module for creating a route to be traveled by the mobile agent, the proximity zone being associated, at least in part, with the route.

6. The system of claim 5 wherein the routing module is configured to create the route as a function of at least one of the requests received from one or more customers and the location of one or more potential customers.

7. The system of claim 5, further comprising an agent contact module configured to transmit the route to the mobile agent device.

8. The system of claim 7 wherein the routing module is configured to update the route as a function of a request from the at least one potential customer and wherein the agent contact module is configured to transmit the updated route to the mobile agent device.

9. The system of claim 8 wherein the customer communication module is configured to transmit a confirmation notification to the at least one potential customer confirming that the updated route of the mobile agent includes the location of the at least one potential customer.

10. The system of claim 7 wherein the routing module is configured to create a schedule for the mobile agent that includes one or more potential customers within the proximity zone having placed a request.

11. The system of claim 10 wherein the routing module is configured to at least one of maximizing a number of customer stops and maximizing a potential revenue generation within the schedule for the mobile agent.

12. The system of claim 1, further comprising a geographic area definition module configured to define the proximity zone associated with the mobile agent.

13. The system of claim 1, further comprising a system management module configured to determine the at least one potential customer as a function of at least one of a profile of the mobile agent and a profile of the potential customer.

14. The system of claim 1 wherein the location signal includes a GPS-based location and the proximity zone is a GPS coordinate-defined geographic location.

15. The system of claim 1 wherein the mobile agent device is selected from the group consisting of a mobile telephone, a PDA, a laptop, and a custom location device.

16. The system of claim 1 wherein the customer notification module is configured to transmit the notification as a function of one or more contact factors selected from the group consisting of a schedule of the mobile agent, an availability of the mobile agent, a proximity of the potential customer location to that of the route, a frequency or history of customer contacts with the potential customer, a mobile agent profile, a customer profile, a customer contact characteristic, an availability of a second mobile agent, and a proximity of a second mobile agent to the customer location.

17. A mobile agent customer contact system comprising:
a memory configured to store a plurality of potential customers including a location of each of the potential customers;
a routing module configured to create a route to be traveled by a mobile agent on a mobile agent schedule;
a geographic area definition module configured to create a proximity zone associated with, at least in part, the route;
a customer location module configured to identify at least one of the potential customers having a location within the proximity zone; and
a customer communication module configured to transmit a notification to the at least one potential customer as a function of the route, the schedule, and a notification event.

18. The system of claim 17 wherein the notification event is selected from the group consisting of a notification time, a notification time interval, a proximity time, a proximity distance, and an arrival time.

19. The system of claim 17, further comprising:
a mobile agent device associated with the mobile agent and configured to transmit a signal indicative of a location of the mobile agent device; and
a mobile agent location module configured to receive the signal and to determine the location of the mobile agent device as a function of the received signal, wherein the notification event is a proximity of the location of the mobile agent device to the at least one potential customer location.

20. The system of claim 17 wherein the customer communication module is configured to prompt the customer to input a customer request and to receive a request from the customer for the mobile agent to travel to the customer location.

21. The system of claim 17, further comprising a routing module configured to create a route to be traveled by the mobile agent as a function of at least one of the requests received from one or more customers and the location of one or more potential customers.

22. The system of claim 21 wherein the customer communication module is configured to prompt the customer to input a customer request and to receive a request from the customer for the mobile agent to travel to the customer location, and the routing module is configured to update the route as a function of the received request.

23. The system of claim 21 wherein the routing module is configured to create a schedule for the mobile agent that includes the customer placing the request.

24. The system of claim 23 wherein the routing module is configured to maximize a factor selected from the group consisting of the number of potential customer stops and the potential revenue generation within the schedule for the mobile agent.

25. The system of claim 17, further comprising an agent contact module configured to transmit the created route to a mobile agent device associated with the mobile agent.

26. The system of claim 17 wherein the customer communication module is configured to prompt the customer to input a customer request and to receive a request from the customer for the mobile agent to travel to the customer location.

27. The system of claim 17, further comprising a system management module configured to determine the at least one potential customer as a function of at least one of a profile of the mobile agent and a profile of the potential customer.

28. The system of claim 17 wherein the customer notification module is configured to transmit the notification as a function of one or more contact factors selected from the group consisting of a schedule of the mobile agent, an availability of the mobile agent, a proximity of the potential customer location to that of the route, a frequency or history of customer contacts with the potential customer, a mobile agent profile, a customer profile, a customer contact characteristic, an availability of a second mobile agent, and a proximity of a second mobile agent to the customer location.

29. A mobile agent customer contact system comprising:
a routing module configured to create a route to be traveled by a mobile agent on a mobile agent schedule;
a geographic area definition module configured to create a proximity zone;
a customer location module including a memory configured for storing a plurality of potential customers and a location of each of the potential customers, the customer location module being configured for identifying at least one of the potential customers having a location within the proximity zone;
a mobile agent device associated with the mobile agent and configured to transmit a location signal indicative of a location of the mobile agent device;
a mobile agent location module configured to receive the signal and to determine the location of the mobile agent device as a function of the received signal;
a customer communication module configured to transmit a notification to the at least one potential customer as a function of the route and the location of the mobile agent device.

30. The system of claim 29 wherein the customer communication module is configured to further transmit the notification as a function of the one or more contact factors selected from the group consisting of the mobile agent schedule, an availability of the mobile agent, a proximity of the at least one potential customer location to that of the route, a frequency or history of customer contacts with the at least one potential customer, a mobile agent profile, a customer profile, a customer contact characteristic, an availability of a second mobile agent, and a proximity of a second mobile agent to the location of the at least one potential customer.

31. The system of claim 29 wherein the customer communication module is configured to further transmit the notification as a function of a notification event selected from the group consisting of a notification time, a notification time interval, a proximity time, a proximity distance, and an arrival time.

32. The system of claim 29 wherein the proximity zone is associated with at least one of the location of the mobile agent and the route.

33. The system of claim 29 wherein the routing module is configured to create the schedule for the mobile agent that includes the location of the at least one potential customer having a location identified by the customer location module.

34. The system of claim 29, further comprising an agent contact module configured to transmit the route to a mobile agent device associated with the mobile agent.

35. The system of claim 29 wherein the customer communication module is configured to prompt the customer to input a customer request and to receive a request from the customer for the mobile agent to travel to the customer location.

36. The system of claim 29, further comprising a system management module configured to determine the at least one potential customer as a function of at least one of a profile of the mobile agent and a profile of the potential customer.
